(19) United States
(12) Patent Application Publication
(10) Pub. No.: US 2014/0372141 A1
(43) Pub. Date: Dec. 18, 2014

(54) DIVERSE METHODS OF FACILITATING A REQUEST FOR PRIOR AUTHORIZATION WITH A COMMON USER EXPERIENCE

(71) Applicant: CoverMyMeds, LLC, Columbus, OH (US)

(72) Inventors: Daniel W. Renner, Pickerington, OH (US); Brian M. Pokosh, Reynoldsburg, OH (US); Matthew A. Scantland, Upper Arlington, OH (US)

(21) Appl. No.: 14/306,193

(22) Filed: Jun. 16, 2014

Related U.S. Application Data
(60) Provisional application No. 61/835,568, filed on Jun. 15, 2013.

(51) Int. Cl. G06F 19/00

(52) U.S. Cl. CPC G06F 19/328
USPC 705/2

(57) ABSTRACT

Provided are a method and computer system for facilitating a request for prior authorization of insurance coverage for a prescribed drug. An appropriate submission protocol is identified from among a plurality of different submission protocols available based on user input received over a communication network. Content is served to be utilized by a user computer for generating a user interface comprising a plurality of data-entry fields in which a user is to enter the patient-related information that is to be submitted as part of the request for prior authorization. The content transmitted is to be used for generating the user interface to include common fields regardless of which of the plurality of different submission protocols is to be utilized, thereby providing users with a transparent, familiar experience to submit a request for prior authorization according to different submission protocols.

### CROSS-REFERENCE TO RELATED APPLICATIONS

This application claims the benefit of U.S. Provisional Application No. 61/835,568, filed Jun. 15, 2013, which is incorporated in its entirety herein by reference.

### BACKGROUND OF THE INVENTION

1. Field of the Invention

This application relates generally to a method and apparatus for requesting prior authorization for fulfillment of a prescription for a drug under the coverage of an insurance plan and, more particularly, to a method and system that utilizes a familiar and consistent user experience to submit a plurality of different types of requests for prior authorization.

2. Description of Related Art

The cost of prescription drugs may be covered by a health insurance plan. At least a portion of the costs of prescription drugs covered by the health insurance plan are paid on behalf of the patient by the health insurance provider. Other prescription drugs falling outside of the coverage of a health insurance plan must be paid for, in full, out of pocket by the patient or other recipient of such prescription drugs.

However, whether a prescription drug is or is not covered by a health insurance plan is not always readily determinable. For example, certain dosages or concentrations of a prescription drug may be covered, while others are not. Likewise, a prescription drug covered as an accepted treatment for a first medical condition may not be covered to treat a different medical condition because it may be uncertain whether the prescription drug constitutes an effective treatment for that different medical condition. A prescription for a drug with a generic equivalent available may also be covered, but only if there is a reason why the generic equivalent is unsuitable.

Under such circumstances when it is unknown whether coverage for a prescription drug is available, a request for prior authorization to fulfill a prescription for a drug under the coverage of a health insurance plan must be submitted. To submit such a request, the pharmacy fulfilling the prescription must enter the required information pertaining to the patient, drug and health insurance plan. The information required and the appropriate form to be completed and submitted can vary by the insurance provider or other benefits manager and possibly by the prescription drug at issue. Further, each insurance provider or other benefits manager may require completed forms to be submitted in different manners, resulting in confusion on the part of users and delays in completing the prior authorization process.

### BRIEF SUMMARY OF THE INVENTION

According to one aspect, the subject application involves a method of facilitating a request for prior authorization of insurance coverage for a prescribed drug. The method includes receiving, with a computer over a communication network, a request to initiate preparation of the request for prior authorization. Based on data received over the communication network, an appropriate submission protocol is identified from among a plurality of different submission protocols available to the computer. The appropriate submission protocol is a submission protocol that has been approved by a party authorized to render a decision on the request for prior authorization for the prescribed drug. Content is transmitted over the communication network to be utilized by a user computer for generating a user interface comprising a plurality of fields in which a user is to enter the patient-related information that is to be formatted into a desired format specific to the appropriate submission protocol as part of the request for prior authorization. The patient-related information entered into the plurality of fields in the user interface is received over the communication network. The received patient-related information is transmitted in a format compliant with the appropriate submission protocol to the deciding party authorized to render the decision on the request for prior authorization. The content transmitted to be utilized for defining the fields of the user interface presented to the user is to be processed by the user computer for generating the user interface to include common fields regardless of which of the plurality of different submission protocols is to be utilized. Examples of the different submission protocols include, but are not limited to, a standard submission and an ePA submission. The common user interface provides users with a transparent, familiar experience to submit a request for prior authorization according to each of the different submission protocols.

According to another aspect, the subject application involves a computer system including a computer processor, a network component for communicating with remotely-located computers over a communication network, and a non-transitory, computer-readable medium programmed with computer-executable logic. When the computer-readable logic is executed by the computer processor, the computer system performs a method of facilitating a request for prior authorization of insurance coverage for a prescribed drug. The method includes receiving, with the network component over a communication network, a request to initiate preparation of the request for prior authorization. Based on data received over the communication network, an appropriate submission protocol is identified from among a plurality of different submission protocols available to the computer. The appropriate submission protocol is a submission protocol that has been approved by a party authorized to render a decision on the request for prior authorization for the prescribed drug. Content is transmitted over the communication network to be utilized by a user computer for generating a user interface comprising a plurality of fields in which a user is to enter the patient-related information that is to be formatted into a desired format specific to the appropriate submission protocol as part of the request for prior authorization. The patient-related information entered into the plurality of fields in the user interface is received over the communication network. The received patient-related information is transmitted in a format compliant with the appropriate submission protocol to the deciding party authorized to render the decision on the request for prior authorization. The content transmitted to be utilized for defining the fields of the user interface presented to the user is to be processed by the user computer for generating the user interface to include common fields regardless of which of the plurality of different submission protocols is to be utilized. Examples of the different submission protocols include, but are not limited to, a standard submission and an ePA submission.

The above summary presents a simplified summary in order to provide a basic understanding of some aspects of the systems and/or methods discussed herein. This summary is not an extensive overview of the systems and/or methods discussed herein. It is not intended to identify key/critical elements or to delineate the scope of such systems and/or methods. Its sole purpose is to present some concepts in a simplified form as a prelude to the more detailed description that is presented later.

### BRIEF DESCRIPTION OF SEVERAL VIEWS OF THE DRAWING

The invention may take physical form in certain parts and arrangement of parts, embodiments of which will be described in detail in this specification and illustrated in the accompanying drawings which form a part hereof and wherein:

FIG. 1 shows an illustrative embodiment of a computerized system for requesting prior authorization of coverage for at least a portion of the cost of a prescription drug;

FIGS. 2A-2D show a block diagram schematically depicting a method of requesting prior authorization according to a plurality of different submission protocols utilizing a common user experience for each.

### DETAILED DESCRIPTION OF THE INVENTION

Certain terminology is used herein for convenience only and is not to be taken as a limitation on the present invention. Relative language used herein is best understood with reference to the drawings, in which like numerals are used to identify like or similar items. Further, in the drawings, certain features may be shown in somewhat schematic form.

It is also to be noted that the phrase “at least one of”, if used herein, followed by a plurality of members herein means one of the members, or a combination of more than one of the members. For example, the phrase “at least one of a first widget and a second widget” means in the present application: the first widget, the second widget, or the first widget and the second widget. Likewise, “at least one of a first widget, a second widget and a third widget” means in the present application: the first widget, the second widget, the third widget, the first widget and the second widget, the first widget and the third widget, the second widget and the third widget, or the first widget and the second widget and the third widget.

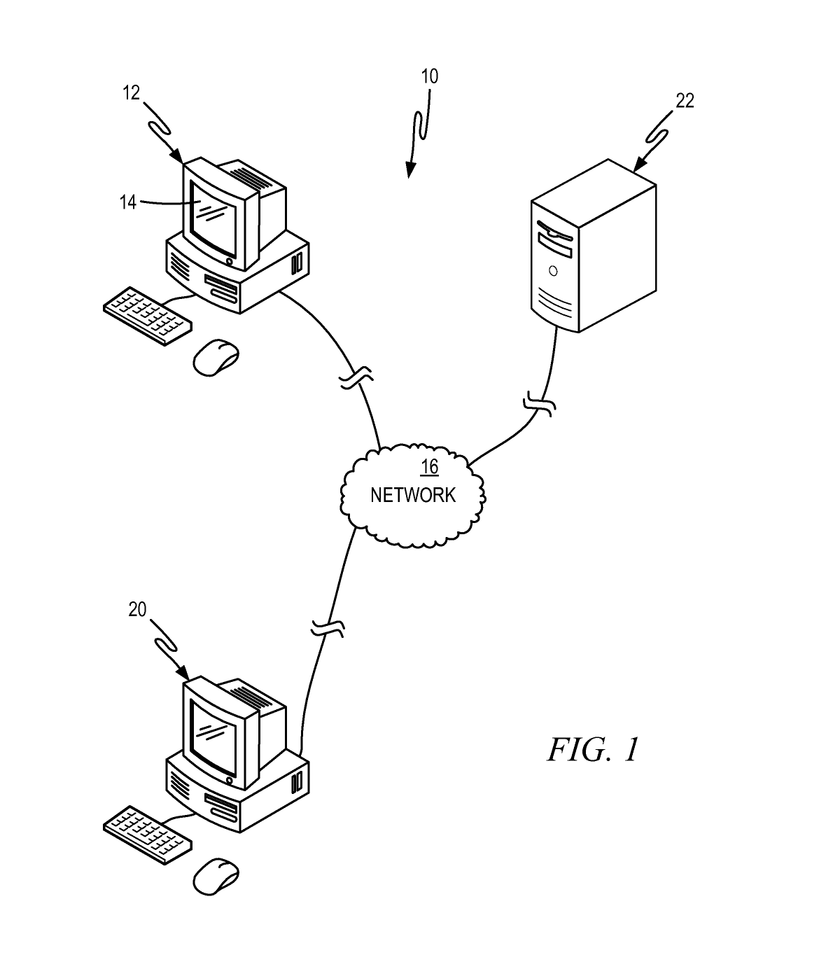

An illustrative embodiment of a distributed computer system 10 that facilitates a method of seeking prior authorization to cover at least a portion of the price of a prescription drug according to an insurance plan is shown in FIG. 1. According to the illustrative embodiment, the system 10 includes a user computer 12 that can be located at a pharmacy, physician's office, or any other location where a user can initiate the process of requesting prior authorization of insurance coverage toward the price of a prescription drug. The user computer can be a general-purpose computer including a non-transitory computer-readable memory, and a monitor 14 that displays various user interfaces including data fields (e.g., free text entry, drop down menus, radio buttons, etc. . . . , and any combination thereof) included in an electronic form in which the user can input data to be submitted as part of the request for prior authorization. A computer processor provided to the user computer 12 can be programmed with computer-executable instructions stored in the memory to generate the user interfaces presented by the monitor 14, receive the user-input information and transmit, via a network component (e.g., Ethernet adapter, 802.1x wireless antenna, etc. . . . ) at least a portion of the user-input information over a communication network 16 (e.g., LAN, WAN such as the Internet or other network using telecommunication lines, a combination thereof, etc. . . . ) to be received by, or on behalf of an insurance provider for a decision on the request for prior authorization. The user interface described herein as being displayed by the user computer 12 can optionally have a graphical appearance as a website, and this graphical appearance can optionally differ from the appearance of the prior authorization request forms generated herein for submission to the insurance provider. For instance, the user interface can include a plurality of fillable fields in which the user can freely enter text (e.g., name of insurance provider, and/or drug name, etc.), select from a plurality of menu options (e.g., state in which insured patient resides), etc.

In addition to the user computer 12 other, similar computers can optionally be included in the system 10. For example, an insurance provider computer 20 can be operatively connected to communicate with the user computer 12 via the communication network 16. The provider computer 20 can include the same, or similar components as the user computer 12, and can optionally be programmed with computer-executable instructions for receiving requests for prior authorization and issuing a response to such requests. The provider computer 20 can be located at an office of the health insurance provider or another party authorized to act on behalf of the health insurance provider, and can be utilized by a representative of the health insurance provider or other party to contribute to the transmission of an answer to the requests for prior authorization in the instances where human involvement is required. The provider computer 20 can optionally include a facsimile card allowing the provider computer 20 to receive fax transmissions from and/or send fax transmissions to stand-alone fax machines connected to the communication network 16. Fax transmissions sent to/received by the provider computer 20 according to such an embodiment are referred to herein as eFax transmissions, as the document is transmitted as a fax transmission from an electronic document without first being printed as a hardcopy that is scanned by a stand-alone facsimile machine. According to alternate embodiments, the provider computer 20 can optionally be accompanied by a stand-alone, dedicated facsimile machine to send/receive traditional fax transmissions, originating from a scanned version of a hardcopy document, over the communication network 16. Yet other embodiments of network communications according to a facsimile protocol can utilize an Internet-based service that serves as a destination where electronic communications such as email, for example, can be sent and converted into a facsimile transmission to be transmitted over a communication network.

A server 22 can optionally be included as part of the system 10 to serve content used by computer terminals such as the user computer 12 and/or provider computer 20. For example, electronic forms such as those in which information is entered by the user via the user computer 12 to submit a request for prior authorization can be served over the communication network 16 by the server 22. Information entered into such forms can be transmitted over the communication network 16, optionally as part of the completed form or at least with data indicative of the field in which each quantity of information was entered (e.g., as XML, JSON, etc. . . . files) to be received by or on behalf of the insurance provider for a decision on the request for prior authorization. The server 22 can optionally be maintained by, or on behalf of a third-party intermediary that is independent of both the user and the health insurance provider.

To minimize confusion of the part of users who submit requests for prior authorization, the system 10 supports the submission of such requests according to a plurality of different protocols, but presents users with a common front end to promote familiarity with submitting requests for prior authorization utilizing any or all of the available protocols for submission of a request for prior authorization. A common front end in the form of a user interface, optionally accessible over the communication network 16 as a website or accessible from a point-of-sale interface for example, can optionally be utilized by the user to complete and submit such requests, regardless of the manner in which the request is ultimately to be submitted to the insurance provider, and/or any other party acting on behalf of the insurance provider, who is to render a decision on the request for prior authorization. In other words, content for generating a common user interface can be served by the server 22, for example, to be utilized by the user computer 12 to generate a fillable user interface with input fields common to a plurality of different prior authorization request forms to be submitted to the insurance provider utilizing different communication protocols. Thus, the user can utilize a familiar front end, regardless of the manner in which the request for prior authorization is to be submitted, and the actual submission can be performed in the background, optionally invisibly to the user.

The user interface can optionally be made accessible to the user in response to, or at least subsequent to receipt of an indication that prior authorization is required for a previously-submitted insurance claim. According to one embodiment, a pharmacist, as the user of the user computer 12, can submit an insurance claim seeking at least partial coverage for a prescribed drug to be dispensed. That claim is routed over the communication network 16 to the provider computer 20 of the insurance provider or other pharmacy benefits manager for a decision concerning the availability of insurance coverage. If the claim is initially rejected and prior authorization is required, a notice to that effect is received by the user computer 12 over the communication network. In response to, or at least subsequent to receiving this notification the user computer 12 can display or otherwise present the user with the option to commence the process of requesting prior authorization at this time. The option can be a button within the claims submission environment on the user computer 12 that is rendered inoperable by the user computer 12 or otherwise made not selectable to initiate the prior authorization request process by the user for that particular transaction prior to receiving the notice that prior authorization has been required. According to such an embodiment, the user interface into which the patient information to be submitted as part of the request for prior authorization can be made specific to requesting prior authorization, and made available for display as appropriate. This can avoid a scenario where the user is presented with the user interface for every patient, regardless of whether prior authorization is required. In this manner, the user can be permitted to enter the patient information into the user interface only when such entry is appropriate, avoiding the perhaps-unnecessary process of entering and maintaining such information for every patient simply because of the possibility such information shall be required in the future.

The party receiving the request for prior authorization can be any intended recipient to which a request for prior authorization can be submitted in the course of receiving a decision on that request. For example, the intended recipient can be the insurance provider, a pharmacy benefits manager, or any other such party involved in rendering a decision on whether to grant prior authorization for fulfillment of a prescription for a drug. For the sake of brevity, however, the party ultimately receiving the request for a decision on prior authorization will be referred to hereinafter, and in the drawings, as the insurance provider.

Likewise, the user can be a pharmacist or other representative of a pharmacy where a prescription was taken to be fulfilled, a physician or other person at the prescribing physician's office, or other person who is to submit a request for prior authorization using the user computer 12. For the sake of brevity, this person will be referred to hereinafter generically as the user.

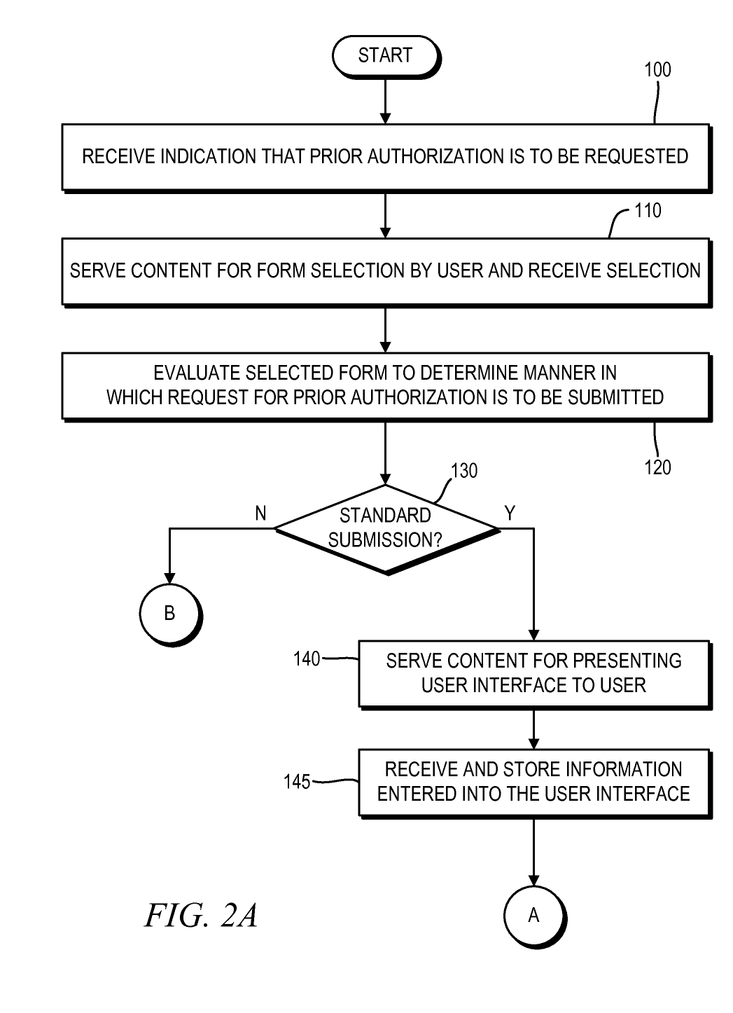

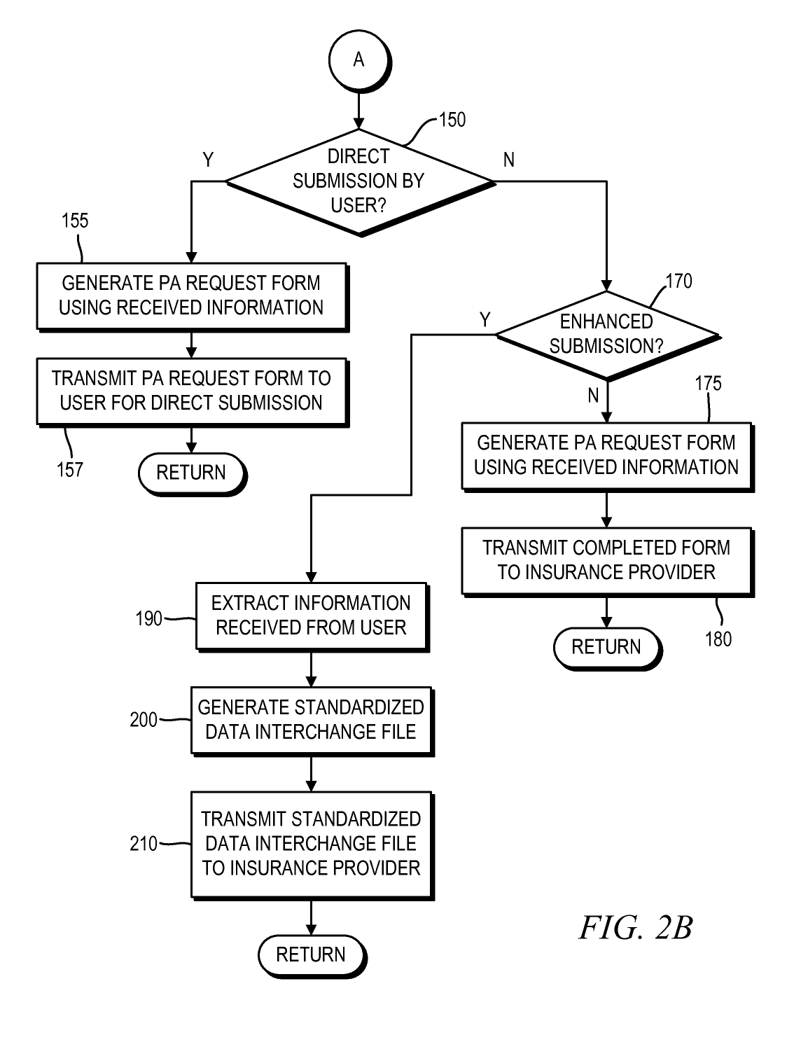

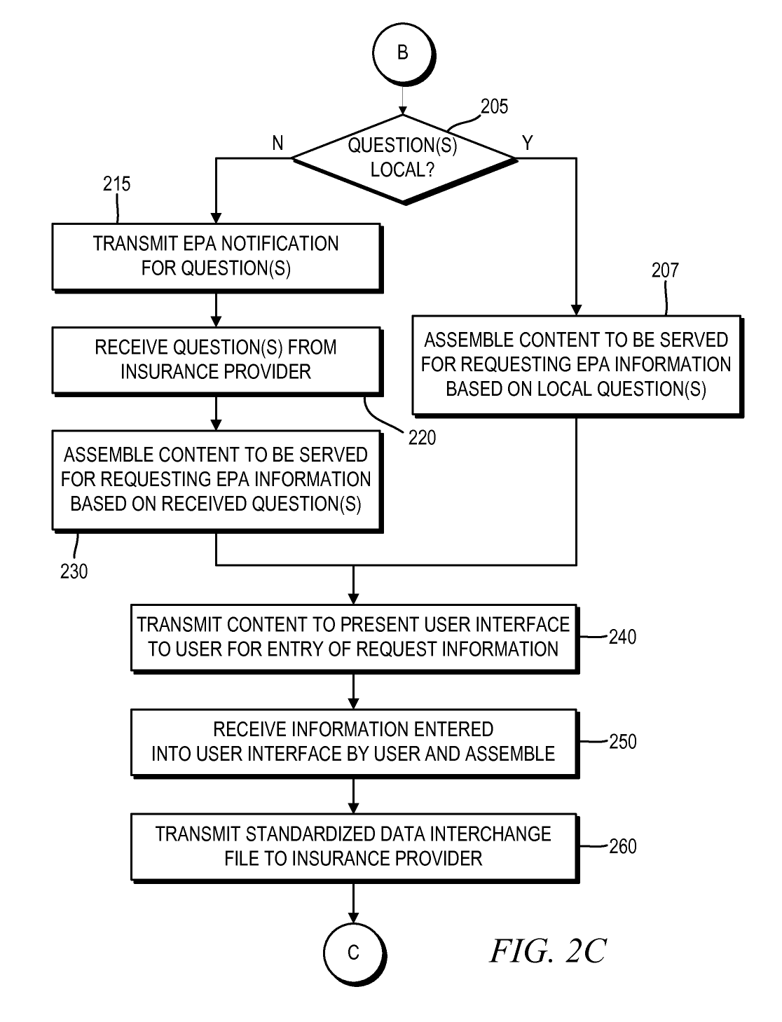

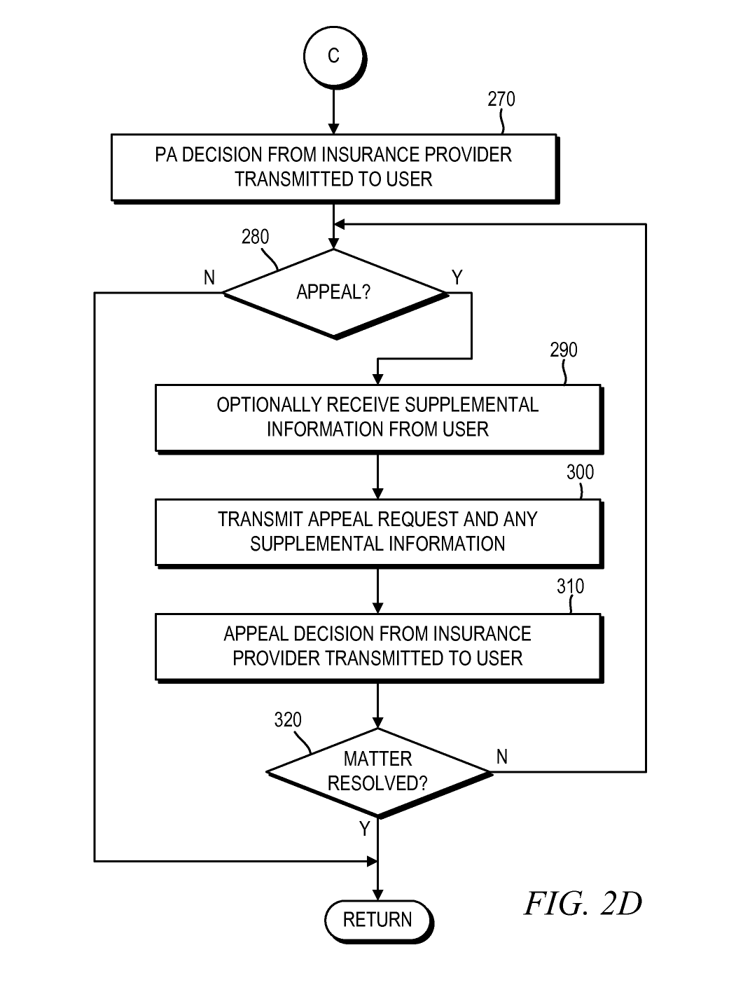

A schematic overview of a method of facilitating a request for prior authorization is depicted in FIGS. 2A-2D. As shown in FIG. 2A, the system 10, or at least a portion thereof (e.g., the server 22) receives a signal over the communication network 16 from the user computer 12, for example, that a request for prior authorization is to be submitted to the health insurance provider at step 100. The signal can optionally come as a visit by the user to a website hosted by the server 22, or in response to selection of a prior authorization option presented in a user interface such as a point-of-sale interface as part of a transaction for the sale of the prescription drug. Examples of requesting prior authorization can be found in U.S. Patent Application Publication No.: 2011/0257992 to Scantland et al., which is incorporated in its entirety herein by reference. Generally, in response to submission of a request for at least partial insurance coverage of the cost of a prescription drug, the insurance provider may initially reject the request, requiring an exception to the reason (e.g., policy limit, generic alternative available, prescribed drug and/or dose outside of patient's plan, etc.) behind the initial refusal of insurance coverage. The request for the insurance provider to overlook the reason behind the initial refusal and agree to at least partially cover the cost of the prescribed drug is referred to herein as a request for prior authorization or a prior authorization request.

In response to receiving this signal or other communication over the communication network 16 suitable to indicate that a prior authorization request is to be submitted, content can be served by the server 22 over the communication network 16 to the user computer 12 at step 110 to allow the user to select the appropriate form to be used to request prior authorization. Selection can optionally involve executing a computer search for the appropriate form based on at least one of the drug, the state in which the insured patient resides, and the health insurance provider as the search criteria in the manner described in Scantland et al. Based on this information, at least one form, and optionally a plurality of candidates returned by the server 22 as the result of a computer search based on the input criteria can be returned. If one possible match is returned as the result, the user can be asked to confirm that the returned form is correct for the particular transaction. If more than one possible form is returned by the search, the user can be asked to make the final selection of the appropriate form from amongst a plurality of candidate forms returned by the search as the best possible matches. Regardless of whether one form is returned or a plurality are returned, the appropriate form to be populated with patient-related information entered via a user interface as described herein for submission can be established as that form confirmed/selected by the user and/or the server 22.

The server 22 or other computer operatively connected to communicate with the server 22 can evaluate the form selected from the database of different forms available and/or information related to the selected form stored in a non-transitory computer-readable medium, in an effort to determine the manner in which this particular form is required to be submitted to the health insurance provider. There can optionally be a single option available, which will be selected by the server 22 by default, or a plurality from which the user can choose. The available submission protocols can optionally be prioritized so that a first submission protocol (e.g., electronic prior authorization (“ePA”) submission, described below) is selected automatically by the server 22, if available, over other available submission protocols such as a standard submission. Such a selection by the server 22 can be automatic based on the selected form, without user intervention, so the process of selecting the type of submission protocol to be utilized from among a plurality of possibilities occurs in the background, in a manner invisible to the user. The manner each form can, or is required to be submitted can be established by the insurance provider, the pharmaceutical company that supplies the drug, or any other third party.

At step 130, it is determined if a standard submission of the request is permissible, or required based on the evaluation of the form selected and/or extraneous information related to the selected form stored in a computer-readable medium. If so, and if this option is selected, the server 22 can serve content over the communication network 16 at step 140 to facilitate the display of a user interface with fillable fields in which data to be populated into the appropriate/selected form to the user on the monitor 14 of the user computer 12. Information entered by the user into the fields in the user interface is received by the server 22 over the communication network and stored at step 145 in a non-transitory computer-readable memory device in communication with (e.g., installed in) the server 22. After receiving and storing this information, the server 22 can determine at step 150 (FIG. 2B) whether the user wishes to submit the generated prior authorization form to the insurance provider directly (e.g., printed as a hardcopy using the user computer 12 and transmitted via fax independently of the server 22), or through the server 22. The desire of the user can be indicated by checking an appropriate check box, or simply by electing to display and/or save and/or print the form locally using the user computer 12. If the user has indicated a desire to submit the prior authorization request form directly, the server 22 generates, at step 155, the prior authorization request form selected as described above by populating the fields therein with the appropriate information entered by the user into the user interface and received by the server 22 over the communication network 16. The generated form is transmitted at step 157 over the communication network 16 to the user so the user can locally print the form to be faxed (or scanned and emailed, sent as an eFax, etc.) directly to the health insurance provider for consideration. If, at step 150, it is determined that this is the manner in which the user has elected to submit the request for prior authorization, the method can be concluded once the form is transmitted to the user to be used in this manner. Under such circumstances, the decision on the request for prior authorization will be conveyed by the insurance provider directly to the user who directly submitted the form, a physician who prescribed the drug, or any other appropriate party in return, without the involvement of the server 22.

If, however, at step 150 it is determined (automatically by the server 22 based on input from the user, through human intervention by a party associated with the server 22, etc. . . . ) that the request for prior authorization will not be submitted directly by the user, but that the request is to be submitted through the involvement of the server 22, then it is determined at step 170 whether the submission is to be an enhanced submission or a simple submission of the form as completed by the user. According to the latter, the selected prior authorization request form is generated by the server 22 at step 175 to include the information entered by the user into the user interface, and is simply forwarded by the server 22 to the health insurance provider at step 180. The user can optionally be required to establish a user account, requiring entry of a login ID and/or password to access information relating to the user's and/or patient's requests for prior authorization. Each such request can optionally be entered into the user account, along with an appropriate status such as submitted, pending, refused, granted, etc. Submitting the completed form to the health insurance provider in this manner can be accomplished as a so-called eFax, for example, which involves the server 22 utilizing traditional facsimile transmission protocols to communicate the completed form to the health insurance provider over a public exchange telephone network, for example. According to alternate embodiments, and optionally as part of a paid service arrangement, a party affiliated with the server 22 (e.g., an employee of a legal entity that operates the server 22, or on whose behalf the server 22 is operated, etc. . . . ) can print a hardcopy of the completed form and feed the completed form to a stand-alone fax machine to be transmitted to a fax number of the health insurance provider. Yet other embodiments can include submitting the form populated with the user-specified information via email, file transfer protocol, or other suitable form of electronic communication. Regardless of whether the completed form is faxed from a hardcopy or eFaxed to the health insurance provider, the form so transmitted is received by the health insurance provider as a flat document, that is simply a combination of form content and the information entered by the user represented by black and white pixels meant to be read by the naked eye. In other words, the form content (e.g., field titles, descriptive text, etc. . . . ) appearing on the blank form and the information entered by the user are interpreted the same by the receiving terminal at the health insurance provider.

If, however, at step 170 in FIG. 2B the submission is determined to be an enhanced submission, then at least a portion of the information entered into the user interface that would be populated into the appropriate fields of the form to be transmitted to the health insurance provider, and optionally other information contained in the selected form, is extracted by the server 22 or other computer at step 190 in FIG. 2B. The form selected by the user and evaluated at step 120 can optionally correspond to a computer-readable form accessible to the server 22 that is compliant with a JSON, XML or other standardized data interchange schema. The server 22 can utilize special characters to denote the information that can be extracted automatically by a computer terminal such as the insurance provider computer 20, another server, or other computer, for example, without manual user intervention. Headings included in such forms adjacent to the special characters or simply the arrangement of the fields can be known to the computer(s) that receive such a form, allowing the computer(s) to compile the information required to be submitted as part of a request for prior authorization. Thus, the information extracted from the user interface presented to the user can be compiled into a standardized data interchange file (e.g., with extension .json, .xml, etc. . . . ) by the server 22 at step 200, which is then transmitted over the communication network 16 to the provider computer 20, a server or other computer terminal at, or affiliated with, the health insurance provider at step 210 for a decision. As opposed to the completed form transmitted according to traditional facsimile protocols, the standardized data interchange file can be parsed by the receiving computer terminal to interpret or otherwise utilize the contents of the standardized data interchange file and determine a context of the data populating that file. The standardized data interchange file is structured to allow for computer transformation of data from a source schema to a target schema, which can optionally be different than the source schema. For instance, variables can be assigned values received in the standardized data interchange file denoted by special characters without manual human intervention. Thus, the data input by the user and included in the standardized data interchange file is considered to be of primary importance relative to any other content of the form presented to the user. The receiving computer can optionally evaluate such data and optionally transmit a predetermined response according to a rules engine programmed for the provider computer 20 based on the evaluated data.

Enhanced submissions enable the important, or at least pertinent data to be evaluated by the receiving computer or another computer in communication with the receiving computer affiliated with the insurance provider without first requiring the receiving computer to sift through the form content and attempt to recognize the data entered by the user. Under certain circumstances defined by a rules engine programmed into the receiving computer at the health insurance provider (or optionally the server 22), for example, certain values extracted from predetermined fields in the form can warrant automatic approval of the request for prior authorization by the receiving computer (or optionally the server 22) without human approval from an authorized human party. The response from the health insurance provider, when submitted through the involvement of the server 22 and regardless of whether a human was involved in reaching the decision on prior authorization, can be returned to the server 22, from where the decision can be accessed by the user via the user computer 12 in the user's account, for example, or transmitted in a communication to the user computer 12.

Referring once again to FIG. 2A, it may be determined at step 130 that the request for prior authorization will be submitted as part of an electronic prior authorization (“ePA”) submission. Although the decision to submit the request as a standard submission at step 130 is discussed above, before the decision to submit the request as an ePA submission, this order of discussion is not indicative of a preference of one form of submission over the other. Although a standard submission can optionally be the first considered option, resorting to the ePA submission as a fallback, other embodiments can check first to determine if the ePA submission is an available option, then resorting to a standard submission if not. According to other embodiments, there may be no preference. Instead, the decision can simply be made to pursue the submission protocol based on the form to be used and/or information relating thereto. This conclusion can be reached in response to evaluation of the form selected and/or information related to the selected form available to the server 22. For example, when the user enters the information for selecting the appropriate form, the server 22 can recognize that the appropriate form for a particular transaction is compatible with the ePA request process. The ePA process is similar to the enhanced submission (affirmative decision at step 170 in FIG. 2B) in that the information entered into the user interface for submission as part of an ePA request is again assembled into a standardized data interchange file for transmission to the health insurance provider instead of being transmitted via facsimile protocol as a flat document. The ePA process differs from the enhanced submission, however, in that the questions included in the user interface and/or information requested to be entered by the user via the user interface for submission as part of the ePA process are/is defined by a question set supplied by the health insurance provider, optionally as a standardized data interchange file. Thus, for an enhanced or standard submission, the content served by the server 22 can be based on the questions presented in the underlying form to be populated with patient-related information. Since the form is an existing document with a predetermined collection of fields to be populated before submission, the content will be served by the server 22 to always generate the same user interface based on this particular form. And since the form can be selected based on the drug, and/or plan, and/or state in which the patient is insured, for example, each request for prior authorization of insurance coverage for a drug will involve the use of the same interface.

In contrast, for an ePA request, a “paper form” may not even exist, or be submitted to the insurance provider. Rather, the patient-related information entered into the user interface displayed by the user computer 12 based on the content served by the server 22 can be received by the server 22 according to a standardized Internet communication protocol (e.g., http). The received information can then be transmitted by the server 22 over the communication network 16 to the provider computer 12, optionally according to a standardized data interchange schema as a data structure rather than a form (in human readable form) populated with the patient-related information. For such an embodiment, a populated form (e.g., containing contextual text and other pre-printed or canned content in addition to the user-input data) may not be generated at all by the server 22 for transmission to the provider computer. The user-input data can be processed by the provider computer 20 in a manner in furtherance of a decision on the prior authorization request.

As used herein, “paper form” refers to a form that is formatted to be read and reviewed by a human being. A paper form will include one or more of headings describing the information appearing in a related field, instructions, and other contextual information that allows a human reader to readily identify and understand the content of the form of interest. The paper form can be thought of as the print view of a document, as opposed to a technical view containing appropriate computer logic symbols and characters that can be machine parsed to extract the information of interest.

According to alternate embodiments of an ePA submission, a paper form (in human-readable format that can be understood by the general reader) can ultimately be generated as an option to include the data submitted by the user to the server 22 via the user interface. For such embodiments, however, the content served by the server 22 and used to generate the user interface is based on a question set that is separate from the underlying paper form, separately received from the insurance provider, optionally in addition to the form. One advantage of such an arrangement is that the question set can be used to identify which data is required from the user, and can optionally be used to drill down, seeking the details of a particular transaction and serve content to include fields in the user interface that may not be included if the content was served to create the user interface based solely on the content of the underlying paper form to be generated. In other words, the content served to be used for generating the user interface for an ePA submission is not necessarily tied to the paper form to be generated, but instead, can be dynamically customized to obtain the requisite information on the fly. The paper form generated according to such an embodiment can optionally be saved on a computer-readable medium accessible to the server 22 for archive or record-keeping purposes, or can be transmitted over the communication network 16 to another destination.

The one or a plurality of questions specified by the insurance provider can be utilized to customize the content served by the server 22 in real time to include, in the user interface, the appropriate questions that must be answered and/or the appropriate information requests for the ePA request to be granted. As described above, the content served by the server 22 to be used to create the user interface for an enhanced submission is based on a standard form and/or related data in a computer-readable medium (e.g., hard disk drive) provided to the server 22. This standard form stored by the server 22 is to be populated with data solicited from the user and is necessary for requesting prior authorization. The user interface content served for an enhanced submission will be the same based on this standard form until that form is replaced or updated in the database of different forms (optionally utilized by different parties) available to the server 22. In contrast, the content served by the server 22 to be used to generate a user interface for an ePA request will involve requesting one or a plurality of questions, or a complete question set from the insurance provider, optionally at a time when the content is to be served by the server 22 to allow the user computer 12 to generate the user interface. Thus, the form that will ultimately be populated and submitted may remain the same, but the question(s) and/or question set can be referenced in real time before such content is served, thereby allowing the user interface to be up to date to request the then-current information required of an approvable ePA submission.

At step 205 in FIG. 2C, it is determined if at least one question, optionally a plurality of questions or a complete question set is already locally available to the server 22 without requiring communication with the insurance provider computer 20, for example. Even though the question(s) is/are stored locally, the availability of updates can be checked and/or received regularly to ensure the question(s) is/are up to date. A preliminary communication with a remote computer such as the provider computer 20 or a related server can optionally be conducted to ensure the locally-stored question(s) is/are up to date. The content to be served by the server 22 for use by the user computer 12 to generate the appropriate user interface is assembled at step 207 based on the locally-stored question(s). Otherwise, if the decision at step 205 is answered in the negative, at step 215 the server 22 transmits an indication to the health insurance provider that the request for prior authorization will be submitted as an ePA request. In response, the server 22 receives one or a plurality of questions, or a complete question set from the health insurance provider at step 220, defining the questions that need to be answered by the user for the ePA request to be granted. The question(s) and/or question set received in response can be used to assemble the content, at step 230, to be served for allowing the user computer 12 to generate a user interface to request the appropriate information for the ePA request. According to an illustrative embodiment, a complete question set can be received by the server 22 and utilized to fully assemble the content to be served for generating the user interface. According to alternate embodiments, one question or a plurality of questions can be received by the server 22 and utilized to assemble content to be served to the user computer for generating a portion, but less than the full user interface requesting all of the information to be submitted as part of the ePA submission. For such embodiments, the server 22 can optionally receive the user-input information requested by the portion of the user interface based on the content originally served, and then communicate with the provider computer 20 or other terminal associated with the insurance provider to request one or more additional, optionally follow-on questions. Content can again be served by the server 22 to the user computer 12, to allow the user computer 12 to display the user interface requesting the information specified by these one or more additional questions. Regardless of whether one or a plurality of such communications are required of the server 22, the content served can cause the user interface to optionally include conditional logic, meaning that a subsequent question included in the user interface presented to the user can be a follow up to a question answered earlier in the user interface, depending upon the answer provided by the user. For example, one question can ask the user if he/she has ever had a certain surgical procedure. If the user answers such a question in the negative, the user can be presented with the next question, which can optionally be unrelated to the earlier question or be directed toward a different topic. However, if the user answers such a question in the affirmative, a new, follow-up question seeking additional details concerning the answer to the previous question, such as asking about the nature of the surgical procedure, or the date the surgical procedure was conducted, for example, can be added to the user interface in real time (e.g., in response to the affirmative answer to the previous question) before the next question directed toward a different topic is asked to solicit all of the information required to be included in the ePA form without presenting the user with unnecessary questions (e.g., asking for the date of a surgical procedure that never occurred).

The conditional logic where a subsequent question included in the user interface can depend on a previous answer is described above for serving content to be used for creating the user interface as part of an ePA submission. However, it is to be understood that such conditional logic can be included in the content served by the server 22 as part of any of the submission protocols discussed herein. For instance, the content served to generate the user interface as part of a standard submission process can include such conditional logic, affecting the content included in the user interface or optionally excluding certain content altogether depending upon an answer previously submitted via the user interface.

Regardless of the questions asked, the ePA form is generated at step 230 based on the question set received by the server 22 from the health insurance provider. The ePA form can be generated by the server 22 and/or by the provider computer 20 in response to receiving data input by the user in the form of a standard data interchange file (e.g., XML, JSON, etc. . . . ), or a non-standardized data interchange file for which the server 22 and the provider computer 20 are configured to recognize. Regardless of whether one or more locally-saved questions or one or more questions received from the insurance provider are utilized to assemble content, the assembled content establishing the fields to be included in the user interface corresponding to the ePA form is transmitted to the user over the communication network 16 at step 240. The information entered into the user interface corresponding to the ePA form by the user at the user computer 12 is received by the server 22 at step 250 and assembled into the standardized data interchange file, or an agreed-upon data interchange file programmed into both the server 22 and the provider computer 20, for example, defined by the question set, before being transmitted to the health insurance provider at step 260. Since the ePA request is submitted to the health insurance provider via the server 22, the decision on the ePA request can optionally be returned to the server 22 or transmitted to the user by the health insurance provider (bypassing the server 22) at step 270 (FIG. 2D) to present the decision to the user. If returned to the server 22, the user can optionally be required to log in to the user account and learn of the decision from the health insurance provider (e.g., in the form of an updated status on a dashboard of a website), and/or the server 22 can optionally transmit a notification of the decision.

In the event of an unfavorable decision on the request for prior authorization where the request was submitted utilizing the server 22, the server 22 can optionally transmit notice of the unfavorable decision, along with an indication of any further information required of the user for reconsideration of the decision as part of an appeal. The server 22 can receive a request to appeal the decision transmitted by the user over the communication network 16. If it is determined that an appeal has not been requested at step 280 in FIG. 2D, then the process can conclude. If, however, an appeal request has been received, the server 22 can optionally receive, at step 290, supplemental information and/or documents from the user over the communication network 16. Such appellate materials can be entered by the user into a user interface generated by the user computer 12 using content transmitted by the server 22 over the communication network 16. According to alternate embodiments, the user can simply elect to re-submit the form and any other information and/or documents originally submitted as part of the request for prior authorization in the first place. The appeal request can be transmitted by the server 22 at step 300 to be received by the health insurance provider, and subsequently receive the decision on appeal issued by the health insurance provider at step 310 to be conveyed to the user (by updating a status on a secure website; transmitted via email, text, or other communication; etc. . . . ). If, at step 320, it is determined that the appeal has brought final resolution to the prior authorization request as indicated by the user (e.g., appeal denied, prior authorization granted, or any other decision on the request), the process is concluded. Otherwise, users can avail themselves to the appellate process again.

The system 10 allows for legacy compatibility with health insurance systems that require prior authorization requests to be submitted using facsimile protocols, yet utilizes a virtual experience including a form that is fillable and likely familiar to users. Further, the same virtual experience can be used to submit ePA requests, making the transition from standard submissions to electronic submissions appear seamless to users.

Illustrative embodiments have been described, hereinabove. It will be apparent to those skilled in the art that the above devices and methods may incorporate changes and modifications without departing from the general scope of this invention. It is intended to include all such modifications and alterations within the scope of the present invention. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A method of facilitating a request for prior authorization of insurance coverage for a prescribed drug, the method comprising:
receiving, with a computer over a communication network, a request to initiate preparation of the request for prior authorization;
based on data received over the communication network, identifying an appropriate submission protocol, from among a plurality of different submission protocols available to the computer, as having been approved by a party authorized to render a decision on the request for prior authorization for the prescribed drug;
transmitting content over the communication network to be utilized by a user computer for generating a user interface comprising a plurality of fields in which a user is to enter the patient-related information that is to be formatted into a desired format specific to the appropriate submission protocol as part of the request for prior authorization;
receiving the patient-related information entered into the plurality of fields in the user interface over the communication network; and
transmitting the patient-related information in a format compliant with the appropriate submission protocol to the deciding party authorized to render the decision on the request for prior authorization, wherein
the content transmitted to be utilized for defining the fields of the user interface presented to the user is to be used for generating the user interface to include common fields regardless of which of the plurality of different submission protocols is to be utilized, the different submission protocols including a standard submission and an ePA submission, providing a common user interface for use with each different submission protocols.

2. The method of claim 1, wherein said identifying the appropriate submission protocol comprises:
establishing a form, from a library of different forms available for submissions to request prior authorization for different prescription drugs, as a selected form to be submitted as part of the request for prior authorization for the prescribed drug; and
based on the selected form, selecting the appropriate submission protocol for that selected form from the plurality of different submission protocols to be used for different forms.

3. The method of claim 3, wherein said establishing the form comprises:
initiating a computer search of the library based on at least one of a name of the prescribed drug, a state in which the patient is insured, and an identity of an insurance provider; and
receiving a selection of the appropriate form from a search result by the user.

4. The method of claim 1, wherein said receiving the patient-related information comprises receiving the patient related information entered by the user into the fields of the user interface according to a standardized network communication protocol.

5. The method of claim 1, wherein said transmitting the patient-related information comprises assembling the patient-related information into a standardized data interchange file comprising the patient-related information in extractable form for electronic submission to the deciding party.

6. The method of claim 1 further comprising establishing a user account corresponding to the user, and updating the user account to indicate a status of the request for prior authorization.

7. The method of claim 6 further comprising:
receiving an unfavorable decision on the request for prior authorization;
updating the user account to reflect receipt of the unfavorable decision; and
transmitting content over the communication network to be utilized by the user computer to display an appeals interface to the user, the appeals interface comprising at least one field in which the user can specify supplemental information to be submitted to the deciding party as an appeal of the unfavorable decision.

8. The method of claim 1, wherein the different submission protocols further comprise an enhanced submission.

9. The method of claim 1, wherein a common user interface is utilized to elicit information to be submitted for requesting prior authorization of the prescribed drug and to elicit information to be included in other requests to be submitted: to request prior authorization of a plurality of different prescription drugs, and/or to different deciding parties.

10. A computer system comprising:
a computer processor;
a network component for communicating with remotely-located computers over a communication network; and
a non-transitory, computer-readable medium programmed with computer-executable logic that, when executed, performs a method of facilitating a request for prior authorization of insurance coverage for a prescribed drug, the method comprising:
receiving, over the communication network using the network component, a request to initiate preparation of the request for prior authorization;
based on data received over the communication network, identifying an appropriate submission protocol, from among a plurality of different submission protocols available to the computer, as having been approved by a party authorized to render a decision on the request for prior authorization for the prescribed drug;
transmitting content over the communication network to be utilized by a user computer for generating a user interface comprising a plurality of fields in which a user is to enter the patient-related information that is to be formatted into a desired format specific to the appropriate submission protocol as part of the request for prior authorization;
receiving the patient-related information entered into the plurality of fields in the user interface over the communication network; and
transmitting the patient-related information in a format compliant with the appropriate submission protocol to the deciding party authorized to render the decision on the request for prior authorization, wherein
the content transmitted to be utilized for defining the fields of the user interface presented to the user is to be used for generating the user interface to include common fields regardless of which of the plurality of different submission protocols is to be utilized, the different submission protocols including a standard submission and an ePA submission, providing a common user interface for use with each different submission protocols.

11. The computer system of claim 10, wherein the computer-readable memory is further programmed with computer-executable instructions that, when executed, cause the computer system to identify the appropriate submission protocol by performing a method comprising:
establishing a form, from a library of different forms available for submissions to request prior authorization for different prescription drugs, as a selected form to be submitted as part of the request for prior authorization for the prescribed drug; and
based on the selected form, selecting the appropriate submission protocol for that selected form from the plurality of different submission protocols to be used for different forms.

12. The computer system of claim 10, wherein the network component receives the patient-related information entered by the user into the fields of the user interface according to a standardized network communication protocol.

13. The computer system of claim 10, wherein the computer processor assembles the patient-related information into a standardized data interchange file comprising the patient-related information in extractable form for electronic submission to the deciding party.

14. The computer system of claim 10, wherein the computer-readable memory is further programmed with computer-executable instructions that, when executed, cause the computer system to further establish a user account corresponding to the user, and updating the user account to indicate a status of the request for prior authorization.

15. The computer system of claim 14, wherein the computer-readable memory is further programmed with computer-executable instructions that, when executed, cause the computer system to perform additional steps comprising:
receiving an unfavorable decision on the request for prior authorization;
updating the user account to reflect receipt of the unfavorable decision; and
transmitting content over the communication network to be utilized by the user computer to display an appeals interface to the user, the appeals interface comprising at least one field in which the user can specify supplemental information to be submitted to the deciding party as an appeal of the unfavorable decision.

16. The computer system of claim 10, wherein the different submission protocols further comprise an enhanced submission.

17. The computer system of claim 10, wherein the computer-executable instructions, when executed, transmit content for a common user interface to be utilized to elicit information to be submitted for requesting prior authorization of the prescribed drug and to elicit information to be included in other requests to be submitted: to request prior authorization of a plurality of different prescription drugs, and/or to different deciding parties.
